(19) United States
(12) Patent Application Publication
(10) Pub. No.: US 2020/0331061 A1
(43) Pub. Date: Oct. 22, 2020

(54) POSITIONING SYSTEM FOR AN ADDITIVE MANUFACTURING MACHINE

(71) Applicant: General Electric Company, Schenectady, NY (US)

(72) Inventors: MacKenzie Ryan Redding, Mason, OH (US); Justin Mamrak, Loveland, OH (US); Donald Dana Lowe, Bow, NH (US); David Scott Simmermon, Felicity, OH (US)

(21) Appl. No.: 16/761,675

(22) PCT Filed: Nov. 2, 2018
(86) PCT No.: PCT/US2018/058838

§ 371 Date: May 5, 2020

Related U.S. Application Data
(60) Provisional application No. 62/584,198, filed on Nov. 10, 2017.

(51) Int. Cl. B22F 3/105; B33Y 50/02

(52) U.S. Cl. CPC B22F 3/1055; B33Y 10/00; B33Y 50/02

(57) ABSTRACT

An additive manufacturing machine (900) including a build unit (904) that is supported by an overhead gantry (912) and a method for positioning the build unit (904) are provided. A positioning system (930) includes one or more position sensors (932) that are separate from the build unit (904) and are configured for obtaining positional data of the build unit (904). The positioning system (930) may continuously track the position and orientation of the build unit (904) and the additive manufacturing machine (900) may adjust the position of the build unit (904) toward a target position.

### PRIORITY INFORMATION

The present applicant claims priority to U.S. Provisional Patent Application Ser. No. 62/584,198 titled “Positioning System for an Additive Manufacturing Machine” filed on Nov. 10, 2017, the disclosure of which is incorporated by reference herein.

### FIELD

The present disclosure generally relates to methods and systems adapted to perform additive manufacturing (AM) processes, for example by direct melt laser manufacturing (DMLM), on a larger scale format.

### BACKGROUND

Additive manufacturing (AM) processes generally involve the buildup of one or more materials to make a net or near net shape (NNS) object, in contrast to subtractive manufacturing methods. Though “additive manufacturing” is an industry standard term (ISO/ASTM52900), AM encompasses various manufacturing and prototyping techniques known under a variety of names, including freeform fabrication, 3D printing, rapid prototyping/tooling, etc. AM techniques are capable of fabricating complex components from a wide variety of materials. Generally, a freestanding object can be fabricated from a computer aided design (CAD) model.

A particular type of AM process uses an energy source such as an irradiation emission directing device that directs an energy beam, for example, an electron beam or a laser beam, to sinter or melt a powder material, creating a solid three-dimensional object in which particles of the powder material are bonded together. AM processes may use different material systems or additive powders, such as engineering plastics, thermoplastic elastomers, metals, and ceramics. Laser sintering or melting is a notable AM process for rapid fabrication of functional prototypes and tools. Applications include direct manufacturing of complex workpieces, patterns for investment casting, metal molds for injection molding and die casting, and molds and cores for sand casting. Fabrication of prototype objects to enhance communication and testing of concepts during the design cycle are other common usages of AM processes.

Selective laser sintering, direct laser sintering, selective laser melting, and direct laser melting are common industry terms used to refer to producing three-dimensional (3D) objects by using a laser beam to sinter or melt a fine powder. More accurately, sintering entails fusing (agglomerating) particles of a powder at a temperature below the melting point of the powder material, whereas melting entails fully melting particles of a powder to form a solid homogeneous mass. The physical processes associated with laser sintering or laser melting include heat transfer to a powder material and then either sintering or melting the powder material. Although the laser sintering and melting processes can be applied to a broad range of powder materials, the scientific and technical aspects of the production route, for example, sintering or melting rate and the effects of processing parameters on the microstructural evolution during the layer manufacturing process have not been well understood. This method of fabrication is accompanied by multiple modes of heat, mass and momentum transfer, and chemical reactions that make the process very complex.

During direct metal laser sintering (DMLS) or direct metal laser melting (DMLM), an apparatus builds objects in a layer-by-layer manner by sintering or melting a powder material using an energy beam. The powder to be melted by the energy beam is spread evenly over a powder bed on a build platform, and the energy beam sinters or melts a cross sectional layer of the object being built under control of an irradiation emission directing device. The build platform is lowered and another layer of powder is spread over the powder bed and object being built, followed by successive melting/sintering of the powder. The process is repeated until the part is completely built up from the melted/sintered powder material.

After fabrication of the part is complete, various post-processing procedures may be applied to the part. Post processing procedures include removal of excess powder by, for example, blowing or vacuuming. Other post processing procedures include a stress release process. Additionally, thermal and chemical post processing procedures can be used to finish the part.

Certain conventional AM machines include a build unit that is supported by an overhead gantry. The gantry defines a build area and facilitates movement of the build unit within the build area to repeatedly deposit layers of powder and fuse portions of each layer to build one or more components. Notably, the weight of the build unit can be pretty substantial, particularly when its powder dispenser is loaded with additive powder. Indeed, in certain situations, the weight of the build unit may be large enough to cause deflections in the gantry beams. Such a deflection in the support structure can cause the position of the build unit to vary relative to a target position, particularly in the center of the build area where the gantry beam deflection is the largest.

Conventional AM machines may compensate for such a deflection in the gantry beam by adjusting a build table along the vertical direction. The vertical adjustment is commonly based on empirical data and intended to compensate for repeatable distortions. Notably, such methods are often ineffective in precisely positioning the build unit due to the large number of factors effecting the gantry beam deflection. For example, external temperatures, wear on gantry components, and the quantity of additive powder contained within the powder dispenser may all affect gantry deflection. Moreover, such compensation techniques are only effective to compensate for repeatable bowing or distortion of a beam due to a single build unit, and are largely ineffective for AM machines including multiple build units.

Accordingly, an AM machine including an improved system for precisely determining the position of the build unit would be desirable. More particularly, a tracking and positioning system for an AM machine that precisely positions one or more build units based on real-time feedback would be particularly beneficial.

### BRIEF DESCRIPTION

Aspects and advantages will be set forth in part in the following description, or may be obvious from the description, or may be learned through practice of the invention.

According to one exemplary embodiment of the present subject matter, an additive manufacturing machine defining a vertical direction and a horizontal plane is provided. The additive manufacturing machine includes a build unit including a powder dispenser and a gantry movably supporting the build unit. A positioning system includes a position sensor, the position sensor being separate from the build unit and being configured for obtaining positional data of the build unit.

According to another exemplary embodiment of the present subject matter, a method of controlling the movement of a build unit of an additive manufacturing machine is provided. The method includes obtaining data indicative of a target position of the build unit, obtaining data indicative of an actual position of the build unit using a positioning system having a position sensor separate from the build unit, and moving the build unit toward the target position.

These and other features, aspects and advantages will become better understood with reference to the following description and appended claims. The accompanying drawings, which are incorporated in and constitute a part of this specification, illustrate embodiments of the invention and, together with the description, serve to explain certain principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended Figs., in which:

FIG. 1 shows a large scale additive manufacturing apparatus according to an embodiment of the invention;

FIG. 2 shows a side view of a build unit according to an embodiment of the invention;

FIG. 3 shows a side view of a build unit dispensing powder according to an embodiment of the invention;

FIG. 4 shows a top view of a build unit according to an embodiment of the invention;

FIG. 5 shows a top view of a recoater according to an embodiment of the present invention;

FIG. 6 illustrates a large scale additive manufacturing apparatus with two build units according to an embodiment of the present invention;

FIG. 7 illustrates a schematic view of a gantry system under deflection and a positioning system for accurately positioning a build unit according to an embodiment of the present invention;

FIG. 8 illustrates a schematic view of a gantry system under deflection and a positioning system for accurately positioning a build unit according to another embodiment of the present invention;

FIG. 9 shows an exemplary control system for use with an additive manufacturing machine and positioning system according to an embodiment of the invention; and

FIG. 10 shows a diagram of an exemplary method of one embodiment of the present invention.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components. In addition, the terms “upstream” and “downstream” refer to the relative direction with respect to fluid flow in a fluid pathway. For example, “upstream” refers to the direction from which the fluid flows, and “downstream” refers to the direction to which the fluid flows. Furthermore, as used herein, terms of approximation, such as “approximately,” “substantially,” or “about,” refer to being within a ten percent margin of error.

An additive manufacturing machine is generally provided which includes a build unit that is supported by an overhead gantry and a method for positioning the build unit are provided. A positioning system includes one or more position sensors that are separate from the build unit and are configured for obtaining positional data of the build unit. The positioning system may continuously track the position and orientation of the build unit and the additive manufacturing machine may adjust the position of the build unit toward a target position.

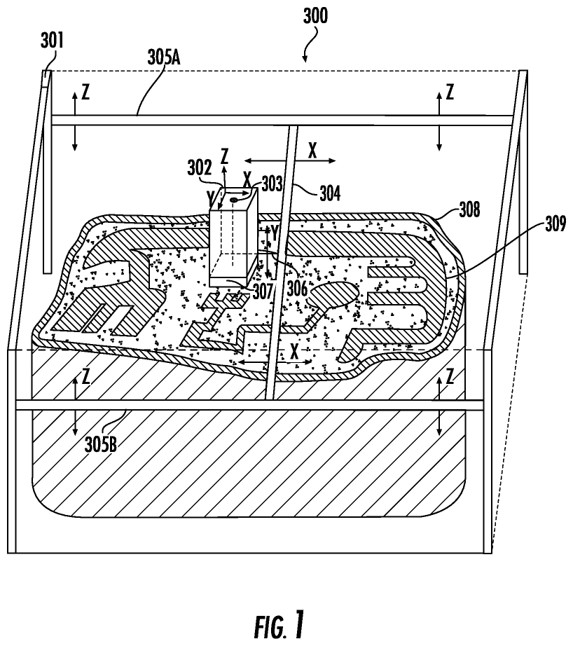

FIG. 1 shows an example of one embodiment of a large-scale additive manufacturing apparatus 300 according to the present invention. The apparatus 300 comprises a positioning system 301, a build unit 302 comprising an irradiation emission directing device 303, a laminar gas flow zone 307, and a build plate (not shown in this view) beneath an object being built 309. The maximum build area is defined by the positioning system 301, instead of by a powder bed as with conventional systems, and the build area for a particular build can be confined to a build envelope 308 that may be dynamically built up along with the object. The gantry 301 has an x crossbeam 304 that moves the build unit 302 in the x direction. There are two z crossbeams 305A and 305B that move the build unit 302 and the x crossbeam 304 in the z direction. The x cross beam 304 and the build unit 302 are attached by a mechanism 306 that moves the build unit 302 in the y direction. In this illustration of one embodiment of the invention, the positioning system 301 is a gantry, but the present invention is not limited to using a gantry. In general, the positioning system used in the present invention may be any multidimensional positioning system such as a delta robot, cable robot, robot arm, etc. The irradiation emission directing device 303 may be independently moved inside of the build unit 302 by a second positioning system (not shown). The atmospheric environment outside the build unit, i.e. the “build environment,” or “containment zone,” is typically controlled such that the oxygen content is reduced relative to typical ambient air, and so that the environment is at reduced pressure.

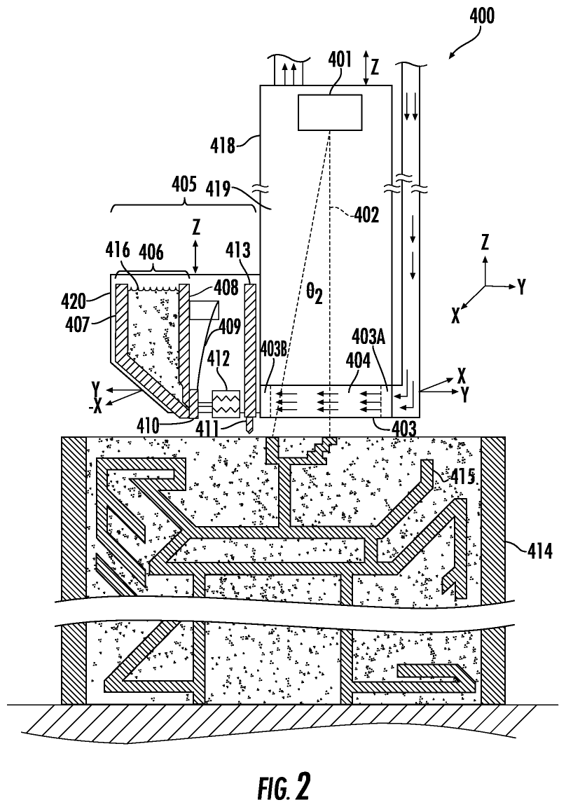

There may also be an irradiation source that, in the case of a laser source, originates the photons comprising the laser beam irradiation is directed by the irradiation emission directing device. When the irradiation source is a laser source, then the irradiation emission directing device may be, for example, a galvo scanner, and the laser source may be located outside the build environment. Under these circumstances, the laser irradiation may be transported to the irradiation emission directing device by any suitable means, for example, a fiber-optic cable. According to an exemplary embodiment, irradiation emission directing device uses an optical control unit for directing the laser beam. An optical control unit may comprise, for example, optical lenses, deflectors, mirrors, and/or beam splitters. Advantageously, a telecentric lens may be used. When a large-scale additive manufacturing apparatus according to an embodiment of the present invention is in operation, if the irradiation emission directing devices directs a laser beam, then generally it is advantageous to include a gasflow device providing substantially laminar gas flow to a gasflow zone as illustrated in FIG. 1, 307 and FIG. 2, 404.

When the irradiation source is an electron source, then the electron source originates the electrons that comprise the e-beam that is directed by the irradiation emission directing device. An e-beam is a well-known source of irradiation. When the source is an electron source, then it is important to maintain sufficient vacuum in the space through which the e-beam passes. Therefore, for an e-beam, there is no gas flow across the gasflow zone (shown, for example at FIG. 1, 307). When the irradiation source is an electron source, then the irradiation emission directing device may be, for example, an electronic control unit which may comprise, for example, deflector coils, focusing coils, or similar elements.

The apparatus 300 allows for a maximum angle of the beam to be a relatively small angle Θ₂ to build a large part, because (as illustrated in FIG. 1) the build unit 302 can be moved to a new location to build a new part of the object being formed 309. When the build unit is stationary, the point on the powder that the energy beam touches when Θ₂ is 0 defines the center of a circle in the xy plane (the direction of the beam when Θ₂ is approximately 0 defines the z direction), and the most distant point from the center of the circle where the energy beam touches the powder defines a point on the outer perimeter of the circle. This circle defines the beam's scan area, which may be smaller than the smallest cross sectional area of the object being formed (in the same plane as the beam's scan area). There is no particular upper limit on the size of the object relative to the beam's scan area.

In some embodiments, the recoater used is a selective recoater. One embodiment is illustrated in FIGS. 2 through 5.

FIG. 2 shows a build unit 400 comprising an irradiation emission directing device 401, a gasflow device 403 with a pressurized outlet portion 403A and a vacuum inlet portion 403B providing gas flow to a gasflow zone 404, and a recoater 405. Above the gasflow zone 404 there is an enclosure 418 containing an inert environment 419. The recoater 405 has a hopper 406 comprising a back plate 407 and a front plate 408. The recoater 405 also has at least one actuating element 409, at least one gate plate 410, a recoater blade 411, an actuator 412, and a recoater arm 413. The recoater is mounted to a mounting plate 420. FIG. 2 also shows a build envelope 414 that may be built by, for example, additive manufacturing or Mig/Tig welding, an object being formed 415, and powder 416 contained in the hopper 405 used to form the object 415. In this particular embodiment, the actuator 412 activates the actuating element 409 to pull the gate plate 410 away from the front plate 408. In an embodiment, the actuator 412 may be, for example, a pneumatic actuator, and the actuating element 409 may be a bidirectional valve. In an embodiment, the actuator 412 may be, for example, a voice coil, and the actuating element 409 may be a spring. There is also a hopper gap 417 between the front plate 408 and the back plate 407 that allows powder to flow when a corresponding gate plate is pulled away from the powder gate by an actuating element. The powder 416, the back plate 407, the front plate 408, and the gate plate 410 may all be the same material. Alternatively, the back plate 407, the front plate 408, and the gate plate 410 may all be the same material, and that material may be one that is compatible with the powder material, such as cobalt-chrome. In this particular embodiment, the gas flow in the gasflow zone 404 flows in the y direction, but it does not have to. The recoater blade 411 has a width in the x direction. The direction of the irradiation emission beam when Θ₂ is approximately 0 defines the z direction in this view. The gas flow in the gasflow zone 404 may be substantially laminar. The irradiation emission directing device 401 may be independently movable by a second positioning system (not shown). FIG. 2 shows the gate plate 410 in the closed position.

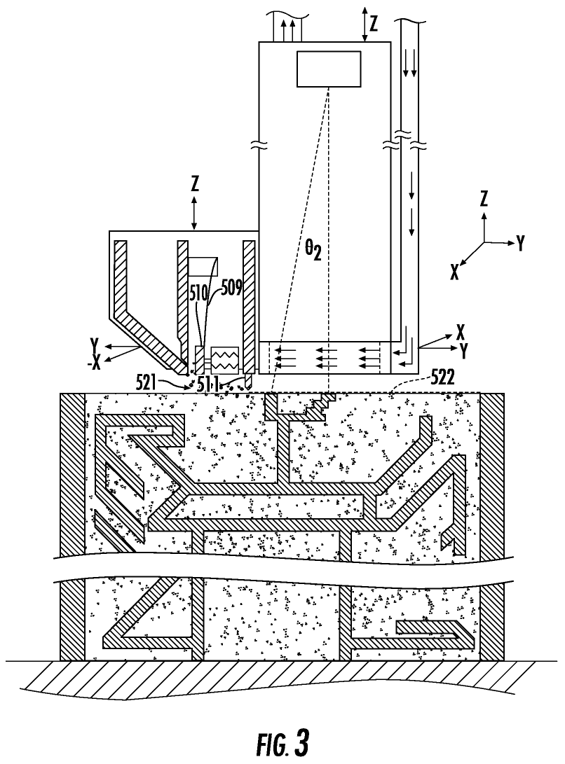

FIG. 3 shows the build unit of FIG. 2, with the gate plate 410 in the open position (as shown by element 510) and actuating element 509. Powder in the hopper is deposited to make fresh powder layer 521, which is smoothed over by the recoater blade 511 to make a substantially even powder layer 522. In some embodiments, the substantially even powder layer may be irradiated at the same time that the build unit is moving, which would allow for continuous operation of the build unit and thus faster production of the object.

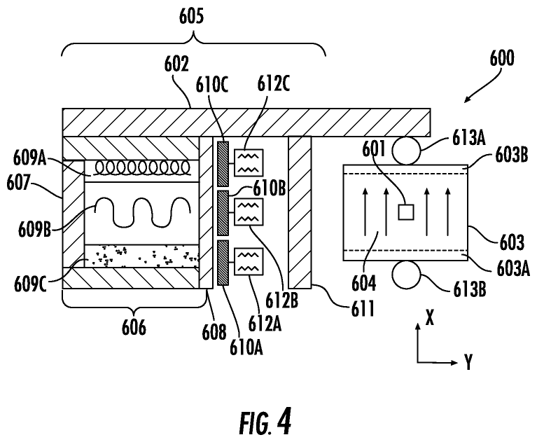

FIG. 4 shows a top down view of the build unit of FIG. 2. For simplicity, the object and the walls are not shown here. The build unit 600 has an irradiation emission directing device 601, an attachment plate 602 attached to the gasflow device 603, hopper 606, and recoater arm 611. The gasflow device has a gas outlet portion 603A and a gas inlet portion 603B. Within the gasflow device 603 there is a gasflow zone 604. The gasflow device 603 provides laminar gas flow within the gasflow zone 604. There is also a recoater 605 with a recoater arm 611, actuating elements 612A, 612B, and 612C, and gate plates 610A, 610B, and 610C. The recoater 605 also has a hopper 606 with a back plate 607 and front plate 608. In this particular illustration of one embodiment of the present invention, the hopper is divided into three separate compartments containing three different materials 609A, 609B, and 609C. There are also gas pipes 613A and 613B that feed gas out of and into the gasflow device 603.

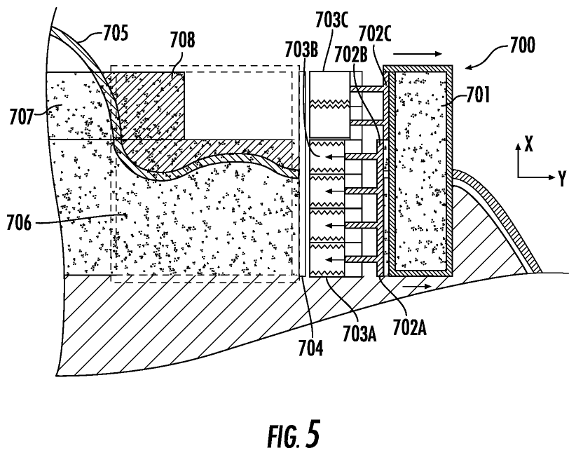

FIG. 5 shows a top down view of a recoater according to one embodiment, where the recoater has a hopper 700 with only a single compartment containing a powder material 701. There are three gate plates 702A, 702B, and 702C that are controlled by three actuating elements 703A, 703B, and 703C. There is also a recoater arm 704 and a wall 705. When the recoater passes over a region that is within the wall, such as indicated by 707, the corresponding gate plate 702C may be held open to deposit powder in that region 707. When the recoater passes over a region that is outside of the wall, such as the region indicated as 708, the corresponding gate plate 702C is closed by its corresponding actuating element 703C, to avoid depositing powder outside the wall, which could potentially waste the powder. Within the wall 705, the recoater is able to deposit discrete lines of powder, such as indicated by 706. The recoater blade (not shown in this view) smooths out the powder deposited.

Advantageously, a selective recoater according to embodiments of the apparatus and methods described herein allows precise control of powder deposition using powder deposition device (e.g. a hopper) with independently controllable powder gates as illustrated, for example, in FIG. 4, 606, 610A, 610B, and 610C and FIG. 5, 702A, 702B, and 702C. The powder gates are controlled by at least one actuating element which may be, for instance, a bidirectional valve or a spring (as illustrated, for example, in FIG. 2, 409. Each powder gate can be opened and closed for particular periods of time, in particular patterns, to finely control the location and quantity of powder deposition (see, for example, FIG. 4). The hopper may contain dividing walls so that it comprises multiple chambers, each chamber corresponding to a powder gate, and each chamber containing a particular powder material (see, for example, FIG. 4, and 609A, 609B, and 609C). The powder materials in the separate chambers may be the same, or they may be different. Advantageously, each powder gate can be made relatively small so that control over the powder deposition is as fine as possible. Each powder gate has a width that may be, for example, no greater than about 2 inches, or more preferably no greater than about ¼ inch. In general, the smaller the powder gate, the greater the powder deposition resolution, and there is no particular lower limit on the width of the powder gate. The sum of the widths of all powder gates may be smaller than the largest width of the object, and there is no particular upper limit on the width of the object relative to the sum of the widths of the power gates. Advantageously, a simple on/off powder gate mechanism according to one embodiment is simpler and thus less prone to malfunctioning. It also advantageously permits the powder to come into contact with fewer parts, which reduces the possibility of contamination. Advantageously, a recoater according to an embodiment of the present invention can be used to build a much larger object. For example, the largest xy cross sectional area of the recoater may be smaller than the smallest cross sectional area of the object, and there is no particular upper limit on the size of the object relative to the recoater. Likewise, the width of the recoater blade may smaller than the smallest width of the object, and there is no particular upper limit on the width of the object relative to the recoater blade. After the powder is deposited, a recoater blade can be passed over the powder to create a substantially even layer of powder with a particular thickness, for example about 50 microns, or preferably about 30 microns, or still more preferably about 20 microns. Another feature of some embodiments of the present invention is a force feedback loop. There can be a sensor on the selective recoater that detects the force on the recoater blade. During the manufacturing process, if there is a time when the expected force on the blade does not substantially match the detected force, then control over the powder gates may be modified to compensate for the difference. For instance, if a thick layer of powder is to be provided, but the blade experiences a relatively low force, this scenario may indicate that the powder gates are clogged and thus dispensing powder at a lower rate than normal. Under these circumstances, the powder gates can be opened for a longer period of time to deposit sufficient powder. On the other hand, if the blade experiences a relatively high force, but the layer of powder provided is relatively thin, this may indicate that the powder gates are not being closed properly, even when the actuators are supposed to close them. Under these circumstances, it may be advantageous to pause the build cycle so that the system can be diagnosed and repaired, so that the build may be continued without comprising part quality. Another feature of some embodiments of the present invention is a camera for monitoring the powder layer thickness. Based on the powder layer thickness, the powder gates can be controlled to add more or less powder.

In addition, an apparatus according to an embodiment of the present invention may have a controlled low oxygen build environment with two or more gas zones to facilitate a low oxygen environment. The first gas zone is positioned immediately over the work surface. The second gas zone may be positioned above the first gas zone, and may be isolated from the larger build environment by an enclosure. For example, in FIG. 2 element 404 constitutes the first gas zone, element 419 constitutes the second gas zone contained by the enclosure 418, and the environment around the entire apparatus is the controlled low oxygen build environment. In the embodiment illustrated in FIG. 2, the first gasflow zone 404 is essentially the inner volume of the gasflow device 403, i.e. the volume defined by the vertical (xz plane) surfaces of the inlet and outlet portions (403A and 403B), and by extending imaginary surfaces from the respective upper and lower edges of the inlet portion to the upper and lower edges of the outlet portion in the xy plane. When the irradiation emission directing device directs a laser beam, then the gasflow device preferably provides substantially laminar gas flow across the first gas zone. This facilitates removal of the effluent plume caused by laser melting. Accordingly, when a layer of powder is irradiated, smoke, condensates, and other impurities flow into the first gasflow zone, and are transferred away from the powder and the object being formed by the laminar gas flow. The smoke, condensates, and other impurities flow into the low-pressure gas outlet portion and are eventually collected in a filter, such as a HEPA filter. By maintaining laminar flow, the aforementioned smoke, condensates and other impurities can be efficiently removed while also rapidly cooling melt pool(s) created by the laser, without disturbing the powder layer, resulting in higher quality parts with improved metallurgical characteristics. In an aspect, the gas flow in the gasflow volume is at about 3 meters per second. The gas may flow in either the x or y direction.

The oxygen content of the second controlled atmospheric environment is generally approximately equal to the oxygen content of the first controlled atmospheric environment, although it doesn't have to be. The oxygen content of both controlled atmospheric environments is preferably relatively low. For example, it may be 1% or less, or more preferably 0.5% or less, or still more preferably 0.1% or less. The non-oxygen gases may be any suitable gas for the process. For instance, nitrogen obtained by separating ambient air may be a convenient option for some applications. Some applications may use other gases such as helium, neon, or argon. An advantage of the invention is that it is much easier to maintain a low-oxygen environment in the relatively small volume of the first and second controlled atmospheric environments. In prior art systems and methods, the larger environment around the entire apparatus and object must be tightly controlled to have a relatively low oxygen content, for instance 1% or less. This can be time-consuming, expensive, and technically difficult. Thus it is preferable that only relatively smaller volumes require such relatively tight atmospheric control. Therefore, in the present invention, the first and second controlled atmospheric environments may be, for example, 100 times smaller in terms of volume than the build environment. The first gas zone, and likewise the gasflow device, may have a largest xy cross sectional area that is smaller than the smallest cross sectional area of the object. There is no particular upper limit on the size of the object relative to the first gas zone and/or the gasflow device. Advantageously, the irradiation emission beam (illustrated, for example, as 402 and 502) fires through the first and second gas zones, which are relatively low oxygen zones. And when the first gas zone is a laminar gasflow zone with substantially laminar gas flow, the irradiation emission beam is a laser beam with a more clear line of sight to the object, due to the aforementioned efficient removal of smoke, condensates, and other contaminants or impurities.

One advantage of the present invention is that, in some embodiments, the build plate may be vertically stationary (i.e. in the z direction). This permits the build plate to support as much material as necessary, unlike the prior art methods and systems, which require some mechanism to raise and lower the build plate, thus limiting the amount of material that can be used. Accordingly, the apparatus of the present invention is particularly suited for manufacturing an object within a large (e.g., greater than 1 m³) build envelope. For instance, the build envelope may have a smallest xy cross sectional area greater than 500 mm², or preferably greater than 750 mm², or more preferably greater than 1 m². The size of the build envelope is not particularly limited. For instance, it could have a smallest cross sectional area as large as 100 m². Likewise, the formed object may have a largest xy cross sectional area that is no less than about 500 mm², or preferably no less than about 750 mm², or still more preferably no less than about 1 m². There is no particular upper limit on the size of the object. For example, the object's smallest xy cross sectional area may be as large as 100 m². Because the build envelope retains unfused powder about the object, it can be made in a way that minimizes unfused powder (which can potentially be wasted powder) within a particular build, which is particularly advantageous for large builds. When building large objects within a dynamically grown build envelope, it may be advantageous to build the envelope using a different build unit, or even a different build method altogether, than is used for the object. For example, it may be advantageous to have one build unit that directs an e-beam, and another build unit that directs a laser beam. With respect to the build envelope, precision and quality of the envelope may be relatively unimportant, such that rapid build techniques are advantageously used. In general, the build envelope may be built by any suitable means, for instance by Mig or Tig welding, or by laser powder deposition. If the wall is built by additive manufacturing, then a different irradiation emission directing device can be used to build than wall than is used to build the object. This is advantageous because building the wall may be done more quickly with a particular irradiation emission directing device and method, whereas a slower and more accurate directing device and method may be desired to build the object. For example, the wall may be built from a rapidly built using a different material from the object, which may require a different build method. Ways to tune accuracy vs. speed of a build are well known in the art, and are not recited here.

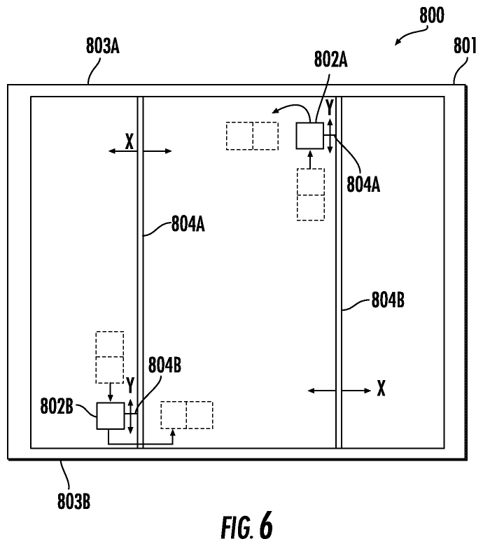

For example, as shown in FIG. 6, the systems and methods of the present invention may use two or more build units to build one or more object(s). The number of build units, objects, and their respective sizes are only limited by the physical spatial configuration of the apparatus. FIG. 6 shows a top down view of a large-scale additive manufacturing machine 800 according to an embodiment of the invention. There are two build units 802A and 802B mounted to a positioning system 801. There are z crossbeams 803A and 803B for moving the build units in the z direction. There are x crossbeams 804A and 804B for moving the build units in the x direction. The build units 802A and 802B are attached to the x crossbeams 804A and 804B by mechanisms 805A and 805B that move the units in the y direction. The object(s) being formed are not shown in this view. A build envelope (also not shown in this view) can be built using one or both of the build units, including by laser powder deposition. The build envelope could also be built by, e.g., welding. In general, any number of objects and build envelopes can be built simultaneously using the methods and systems of the present invention.

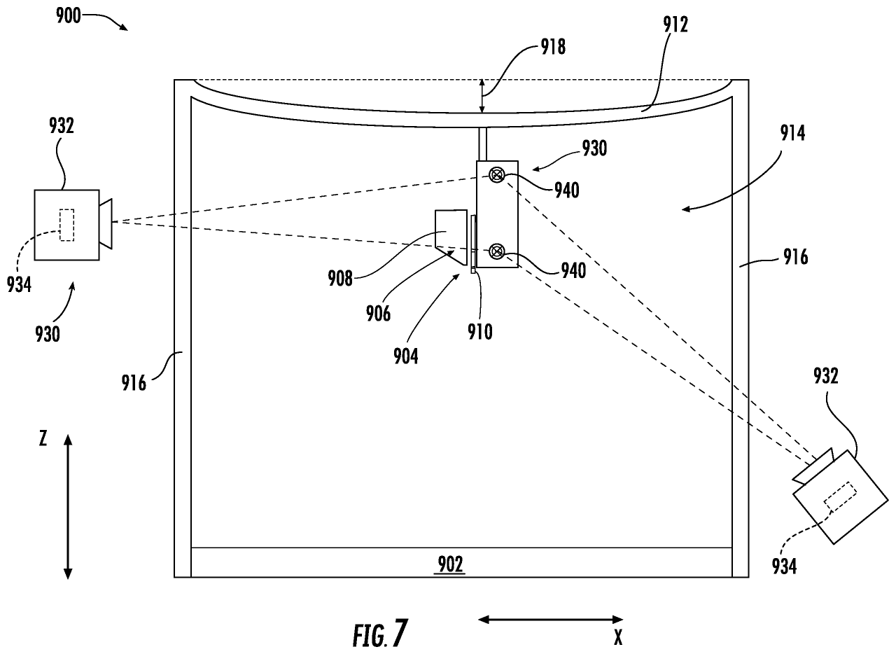

Referring now to FIG. 7, an additive manufacturing machine 900 generally defines a vertical or Z-direction and a horizontal plane defined perpendicular to the Z-direction (also as defined, e.g., by the X-direction and the Y-direction in FIG. 1). Build platform 902 extends within the horizontal plane to provide a surface for depositing layers of additive powder (not shown in FIG. 7), as described herein. In general, additive manufacturing machine 900 includes a build unit 904 that is generally used for depositing a layer of additive powder and fusing portions of the layer of additive powder to form a single layer of a component (not illustrated in FIG. 7). As described above, build unit 904 forms the component layer-by-layer by printing or fusing layers of additive powder as build unit 904 moves up along the vertical direction.

Build unit 904 generally includes a powder dispenser 906 for discharging a layer of additive powder and an energy source (not shown in FIG. 7, see 303 in FIG. 1) for selectively directing energy toward the layer of additive powder to fuse portions of the layer of additive powder. For example, powder dispenser 906 may include a powder hopper 908, a system of gates (see, e.g., FIG. 4, 610A-C and FIG. 5, 702A-C), a recoater arm 910, and any other components which facilitate the deposition of smooth layers of additive powder on build platform 902 or a sub layer. In addition, “energy source” may be used to refer to any device or system of devices configured for directing an energy beam towards a layer of additive powder to fuse a portion of that layer of additive powder. For example, according to an exemplary embodiment, energy source may be an irradiation emission directing device, as described above.

As described above, build unit 904 is described as utilizing a direct metal laser sintering (DMLS) or direct metal laser melting (DMLM) process using an energy source to selectively sinter or melt portions of a layer of powder. However, it should be appreciated that according to alternative embodiments, additive manufacturing machine 900 and build unit 904 may be configured for using a “binder jetting” process of additive manufacturing. In this regard, binder jetting involves successively depositing layers of additive powder in a similar manner as described above. However, instead of using an energy source to generate an energy beam to selectively melt or fuse the additive powders, binder jetting involves selectively depositing a liquid binding agent onto each layer of powder. For example, the liquid binding agent may be a photo-curable polymer or another liquid bonding agent. Other suitable additive manufacturing methods and variants are intended to be within the scope of the present subject matter.

Notably, according aspects of the present subject matter, build unit 904 is supported by a gantry 912 that is positioned above build platform 902 and at least partially defines a build area 914. Notably, as used herein, “gantry” 912 may be intended to refer to the horizontally extending support beams and not the vertical support legs 916 that support the gantry 912 over the build platform 902. Although a gantry 912 is used to describe the support for build unit 904 herein, it should be appreciated that any suitable vertical support means can be used according to alternative embodiments. For example, build unit 904 may be attached to a positioning system such as a delta robot, a cable robot, a robot arm, a belt drive, etc. In addition, although build platform 902 is illustrated herein as being stationary, it should be appreciated that build platform 902 may move according to alternative embodiments. In this regard, for example build platform 902 may be configured for translating along the X-Y-Z directions or may rotate about one of these axes.

According to the illustrated embodiment, gantry 912 defines a build area 914 having a maximum build width (e.g., measured along the X-direction), build depth (e.g., measured along the Y-direction), and build height (measured along the vertical direction or Z-direction). Gantry 912 is generally configured for movably supporting build unit 904 within build area 914, e.g., such that build unit 904 may be positioned at any location (e.g., along X-Y-Z axes) within build area 914. Moreover, according to exemplary embodiments, gantry 912 may further be configured for rotating build unit about the X, Y, and Z axes. Thus, build unit 904 may be positioned and oriented in any suitable manner within build area 914 to perform an additive manufacturing process.

As explained briefly above, additive manufacturing machine 900 may include one or more build units 904. Notably, each build unit 904 is movably supported by gantry 912 such that it may move throughout build area 914. However, due to the weight of build unit 904 (particularly when fully loaded with additive powder), and due to the length of the supporting arm of gantry 912, the gantry 912 may sag or flex slightly due to the exerted forces. For example, as illustrated in FIG. 7, gantry 912 may define a maximum deflection 918 relative to an unloaded state. Notably, given the extremely precise manufacturing tolerances associated with additive manufacturing machine 900 (e.g., as small as 10 μm or smaller according to exemplary embodiments), even a slight flexing or displacement of the gantry 912 can cause serious performance and/or operational issues with additive manufacturing machine 900. In order to improve the positioning of build unit 904, the precision of the powder feed, and the printing resolution of build unit 904, a system and method of compensating for sag or flexing of gantry 912 and improving the overall positioning of build unit 904 is described below.

Referring still to FIG. 7, a positioning system 930 of additive manufacturing machine 900 will be described according to an exemplary embodiment of the present subject matter. Positioning system 930 is generally configured for detecting the actual position of build unit 904 and moving build unit 904 to reach a target position. Alternatively, when additive manufacturing machine 900 includes multiple build units 904, positioning system 930 may be configured for moving each build unit 904 to a respective target position. For simplicity, the discussion below focuses on an additive manufacturing machine 900 with a single build unit 904.

As illustrated, positioning system includes a position sensor 932 that is separate from build unit 904 and is configured for obtaining positional data of build unit 904. As used herein, “position” and “positional data” may refer to any information or data indicative of the location and/or orientation of build unit 904 within the three-dimensional build area 914, e.g., in up to six degrees of freedom. In this regard, for example, positional data may refer to the position of build unit 904 within a 3-D space (e.g., X-Y-Z coordinates within X-Y-Z axes defining build area 914) as well as the angular position of build unit 904 about three axes (e.g., pitch, yaw, and roll or rotation about the X-Y-Z axes). According to alternative embodiments, positional data may further include data associated with the velocity, acceleration, vibration, and trajectory of build unit 904. In addition, it should be appreciated that “position,” as used herein, may be used generally to refer to the translational location of build unit 904 within a three-dimensional space, the orientation of build unit 904 within that space, or both.

According to the illustrated embodiment, position sensor 932 is located remote from build unit 904, e.g., external to gantry 912. More specifically, according to an exemplary embodiment, position sensor 932 is located in a fixed position relative to gantry 912. In addition, according to an exemplary embodiment, position sensor 932 is located outside of build area 914.

Position sensor 932 may be any sensor or sensor system for detecting the location and/or orientation of build unit 904, or more specifically, any specific point or points on build unit 904. For example, according to the illustrated embodiment, position sensor 932 is an optical tracking system or laser tracking system. In this regard, for example, position sensor 932 may include a photodiode 934 or other suitable optical sensor. However, according to alternative embodiments, position sensor 932 may rely on principles of electromagnetism or may be a contact probe for precisely detecting positional data of build unit 904. Other devices for measuring positional data of build unit 904 are possible and within the scope of the present subject matter.

Moreover, positioning system 930 may include a plurality of position sensors 932 positioned proximate additive manufacturing machine 900 for detecting the position of build unit 904 or particular locations on build unit 904. According to one exemplary embodiment, each of the plurality of position sensors 932 simultaneously collect the positional data of build unit 904 and the collected data from all position sensors 932 is combined using a sensor fusion algorithm.

More specifically, each position sensor 932 may produce positional data related to each build unit 904. This data may be compiled (e.g., using a control system such as control system 150 described below) using a process referred to herein as “sensor fusion.” In general, sensor fusion is a process by which data from each of the position sensors 932 is combined to compute something more than could be determined by any one position sensor 932 alone. In this regard, for example, by compiling the data from multiple position sensors 932 and/or measurements of a single build unit 904, the position and orientation of build unit 904 may be determined with a very high degree of accuracy. More specifically, for example, if the position measurement of a first position sensor 932 and a second position sensor 932 differ by a small amount, splitting the difference between the two position sensors 932 will typically provide a more accurate position measurement. Similarly, data averaging, triangulation, and other geometric or mathematic methods may be used to obtain positional data for a build unit 904. Thus, sensor fusion may be used to form a more complete, a more accurate, and a more reliable picture of the exact position of build unit 904 at any given time. Moreover, a controller (such as control system 150) may use this information to reposition or orient build unit 904 as needed for improved printing.

In order to improve the accuracy of the positional data of build unit 904, positioning system 930 may include one or more tracking targets 940. Tracking targets 940 may be any mark, indicator, feature, or other characteristic defined by or on build unit 904 to facilitate easy detection or interrogation by position sensor 932. For example, tracking targets 940 may be small reflective dots placed on build unit 904 for detection by position sensor 932. Position sensor 932 may locate and track the tracking targets 940 to obtain the precise position of build unit 904 at any time. According to an exemplary embodiment, tracking target 940 is positioned at a bottom of build unit 904, e.g., proximate the layer of additive powder where precise positioning may be most important.

Although two tracking targets 940 are illustrated in FIG. 7, it should be appreciated that any suitable number, type, and position of tracking targets 940 may be used according to alternative embodiments. Each of these tracking targets 940 may be tracked or detected by a single position sensor 932 or by multiple position sensors 932 in any suitable combination. For example build unit 904 may have a single tracking target 940 or more than two tracking targets 940. In addition, positioning system 930 may include multiple position sensors 932. According to one exemplary embodiment, each position sensor 932 may be configured for obtaining positional data regarding each tracking target 940, this data may be averaged, combined, or otherwise manipulated to form a more precise determination of the position of build unit 904 (e.g., using a sensor fusion approach as described above).

Notably, positioning system 930 may be capable of determining positional data for more than one build unit 904 simultaneously. Thus, for example, additive manufacturing machine 900 may include two or more build units 904, each of which operate within the same build area 914 to print one or more components. Use of multiple build units 904 is useful for increasing the printing speed. However, in conventional additive manufacturing machines, using multiple build unit may be difficult or impossible, particularly when the supported by the same gantry, because the degree of flex in the gantry depends on the location of the build unit.

However, by using positions sensors 932 that are remote from the build unit 904 and/or tracking targets 940 positioned on each build unit 904, positional data related to each of the build units 904 may be simultaneously obtained and used to independently control the position and orientation of the build units 904. Therefore referring briefly to FIG. 6, additive manufacturing machine 800 may include in the second build unit positioned within a build area. The first tracking target (not shown) may be positioned on the first build unit 802A and a second tracking target (not shown) position of the second build unit 802B. Although more than one position sensor (not shown) may be used, according to the illustrated embodiment, a single position sensor is used to track the location of build unit(s) 802A, 802B using first tracking target and second tracking target, respectively. In this manner, the speed of manufacturing process may be increased, e.g., by two times or more, without sacrificing precision of the final product.

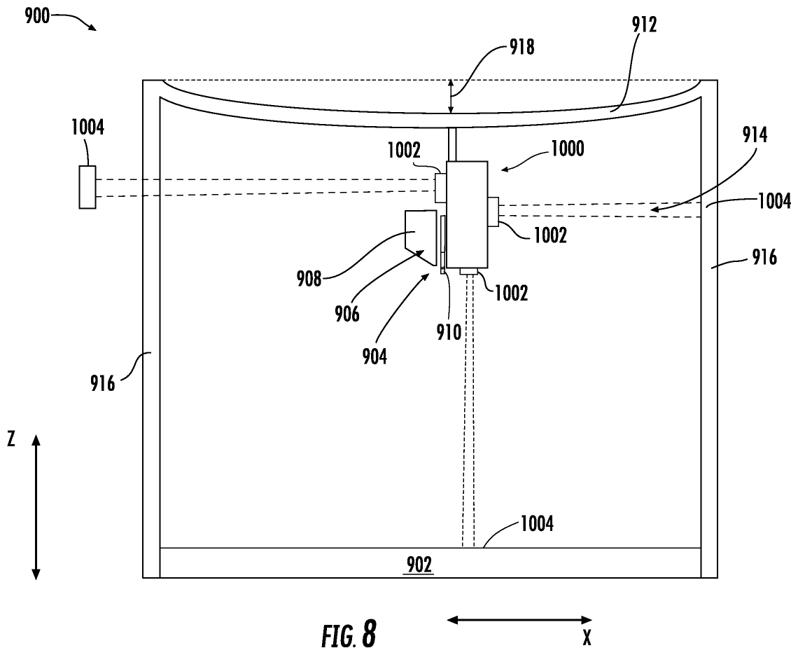

As illustrated in FIG. 7, positioning system 930 includes one or more position sensors 932 positioned remote from build unit 904 for tracking the position of build unit 904. However, it should be appreciated that the orientation of the position sensors and tracking targets may be flipped according to alternative embodiments. For example, referring now to FIG. 8, a positioning system 1000 will be described according to an alternative embodiment. Due to the similarity between embodiments, like reference numerals may be used to refer to the same or similar features in FIGS. 7 and 8.

As illustrated, positioning system 1000 includes a plurality of range finders or position sensors 1002 positioned on build unit 904. In this manner, position sensors 1002 are configured for detecting the distance to a known reference location or object 1004. Reference object 1004 may be a vertical support leg 916 of gantry 912, a wall of additive manufacturing machine 900, or any other object having a known location relative to build platform 902. In this manner, positioning system 1000 may use position sensors 1002 to determine the exact position of build unit 904 relative to reference objects 1004, and thus the position of build unit 904 within build area 914.

Similar to the embodiments described above, positioning system 1000 may use tracking targets to facilitate detection by position sensors 1002. In addition, multiple position sensors 1002 may be used and a sensor fusion algorithm may be used to improve the accuracy of the position of build unit 904. Moreover, additive manufacturing machine 900 may have multiple build units 904, each of which may include one or more position sensors 1002 for detecting the position of the build units 904 relative to fixed reference objects 1004 and/or other build units 904.

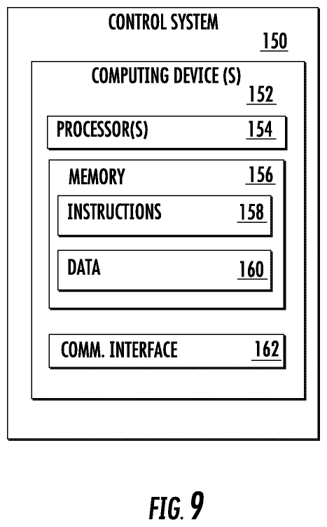

FIG. 9 depicts a block diagram of an example control system 150 that can be used to implement methods and systems according to example embodiments of the present disclosure, particularly the operation of additive manufacturing machine 900 and positioning systems 930, 1000. In this regard, for example, control system 150 may be configured for regulating the position of build unit 904 (or multiple build units 904). Specifically, according to the illustrated embodiment, control system 150 is operably coupled to position sensor 932 and gantry 912 for determining a target position of the build unit 904, using the position sensor 932 to obtain an actual position of the build unit 904, and moving the build unit 904 toward the target position. For example, control system 150 may determine an error value between the target position and the actual position and may manipulate gantry 912 and/or build unit 904 to minimize the error. Control system 150 may be a dedicated controller of positioning systems 930, 1000 or may be a primary controller of additive manufacturing machine 900. The control system 150 may be positioned in a variety of locations throughout additive manufacturing machine 900.

As shown, the control system 150 can include one or more computing device(s) 152. The one or more computing device(s) 152 can include one or more processor(s) 154 and one or more memory device(s) 156. The one or more processor(s) 154 can include any suitable processing device, such as a microprocessor, microcontroller, integrated circuit, logic device, or other suitable processing device. The one or more memory device(s) 156 can include one or more computer-readable media, including, but not limited to, non-transitory computer-readable media, RAM, ROM, hard drives, flash drives, or other memory devices.

The one or more memory device(s) 156 can store information accessible by the one or more processor(s) 154, including computer-readable instructions 158 that can be executed by the one or more processor(s) 154. The instructions 158 can be any set of instructions that when executed by the one or more processor(s) 154, cause the one or more processor(s) 154 to perform operations. The instructions 158 can be software written in any suitable programming language or can be implemented in hardware. In some embodiments, the instructions 158 can be executed by the one or more processor(s) 154 to cause the one or more processor(s) 154 to perform operations, such as the operations for controlling the positioning of build unit 904 using positioning systems 930, 1000 or otherwise operating additive manufacturing device 900.

The memory device(s) 156 can further store data 160 that can be accessed by the one or more processor(s) 154. For example, the data 160 can include any data used for operating positioning systems 930, 1000 and/or additive manufacturing machine 900, as described herein. The data 160 can include one or more table(s), function(s), algorithm(s), model(s), equation(s), etc. for operating positioning systems 930, 1000 and/or additive manufacturing machine 900 according to example embodiments of the present disclosure.

The one or more computing device(s) 152 can also include a communication interface 162 used to communicate, for example, with the other components of system. The communication interface 162 can include any suitable components for interfacing with one or more network(s), including for example, transmitters, receivers, ports, controllers, antennas, or other suitable components.

Now that the construction and configuration of additive manufacturing machine 900 and positioning systems 930, 1000 according to an exemplary embodiment of the present subject matter has been presented, an exemplary method 1100 for controlling the movement of a build unit of an additive manufacturing machine according to an exemplary embodiment of the present subject matter is provided. Method 1100 can be used by a manufacturer to control additive manufacturing machine 900, or any other suitable additive manufacturing machine or assembly. It should be appreciated that the exemplary method 1100 is discussed herein only to describe exemplary aspects of the present subject matter, and is not intended to be limiting.

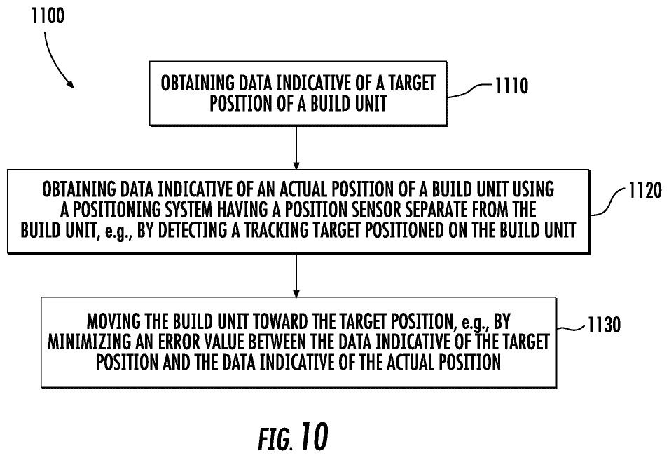

Referring now to FIG. 10, method 1100 includes, at step 1010, obtaining data indicative of a target position of the build unit. As an example, this target position may be extracted from a print file or computer aided design (CAD) model typically loaded into the control system of the additive manufacturing machine. Alternatively, the target position of the build unit may be set by a user or determined using any other method.

Method 1100 further includes, at step 1120, obtaining data indicative of an actual position of the build unit using a positioning system having a position sensor separate from the build unit. Continuing the example from above, positioning system may include one or more position sensors and one or more tracking targets positioned on the build unit for determining the positional data. In addition, as described above, all of the collected data from any suitable number of sensors and tracking targets, may be combined using a sensor fusion algorithm to determine precisely the position and orientation of the build unit in up to six degrees of freedom.

Method 1100 includes, at step 1130, moving the build unit toward the target position, e.g., to minimize an error value between the data indicative of the target position and the data indicative of the actual position. In other words, step 1130 includes moving the build unit to the target position. In this manner, method 1100 provides a closed-loop control system for ensuring that build unit continuously and accurately tracks its target position, resulting in an improved printing process. It should be further appreciated that method 1100 can also be used to track and regulate the position of two or more of build units.

FIG. 10 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 1100 are explained using additive manufacturing machine as an example, it should be appreciated that these methods may be applied to control any suitable additive manufacturing machine or positioning system.

The positioning system described above provides several advantages compared to conventional positioning systems. For example, by using a position sensor positioned separate and remote from the build unit, the positioning system may compensate for the effects of beam deflection. Moreover, closed loop control of the position of build unit ensures an accurate printing process and higher quality results. Moreover, less expensive gantry or build unit positioning systems may be used because any errors may be compensated for instantaneously. Other advantages to positioning system will be apparent to those skilled in the art.

This written description uses exemplary embodiments to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An additive manufacturing machine (900) defining a vertical direction (V) and a horizontal plane (H), the additive manufacturing machine (900) comprising:
a build unit (904) comprising a powder dispenser (906);
a gantry (912) movably supporting the build unit (904); and
a positioning system (930) comprising a position sensor (932), the position sensor (932) being configured for obtaining positional data of the build unit (904).

2. The additive manufacturing machine (900) of claim 1, wherein the positioning system (930) further comprises a tracking target (940) positioned on the build unit (904), the position sensor (932) configured for detecting the tracking target (940) to obtain the positional data.

3. The additive manufacturing machine (900) of claim 2, wherein the positioning system (930) comprises a plurality of tracking targets (940) positioned at different locations on the build unit (904).

4. The additive manufacturing machine (900) of claim 2, wherein the tracking target (940) is positioned at a bottom of the build unit (904).

5. The additive manufacturing machine (900) of claim 1, wherein the positioning system (930) is an optical or laser tracking system.

6. The additive manufacturing machine (900) of claim 5, wherein the position sensor (932) comprises a photodiode (934).

7. The additive manufacturing machine (900) of claim 1, wherein the position sensor (932) is in a fixed position relative to the gantry (912).

8. The additive manufacturing machine (900) of claim 1, wherein the position sensor (932) is positioned external to the gantry (912).

9. The additive manufacturing machine (900) of claim 1, wherein the positioning system (930) includes a plurality of position sensors (932).

10. The additive manufacturing machine (900) of claim 9, wherein the plurality of position sensors (932) collect the positional data of the build unit (904), the positional data from each of the plurality of position sensors (932) being combined using a sensor fusion algorithm.

11. The additive manufacturing machine (900) of claim 1, wherein the positional data comprises a position and an orientation of the build unit (904) in six degrees of freedom.

12. The additive manufacturing machine (900) of claim 1, wherein the build unit (904) is a first build unit (802A), the additive manufacturing machine (900) further comprising:
a second build unit (802B) comprising a second powder dispenser (906), wherein the positioning system (930) is configured for obtaining positional data of the first build unit (802A) and the second build unit (802B).

13. The additive manufacturing machine (900) of claim 1, further comprising a controller (150) operably coupled with the gantry (912) and the positioning system (930), the controller (150) being configured for:
obtaining data indicative of a target position of the build unit (904);
obtaining data indicative of an actual position of the build unit (904) using the position sensor (932); and
moving the build unit (904) toward the target position.

14. A method (1100) of controlling the movement of a build unit of an additive manufacturing machine, the method comprising:
obtaining data indicative of a target position of the build unit (1110);
obtaining data indicative of an actual position of the build unit using a positioning system having a position sensor operably coupled to the build unit (1120); and
moving the build unit toward the target position (1130).

15. The method (1100) of claim 14, wherein moving the build unit toward the target position (1130) comprises minimizing an error value between the data indicative of the target position and the data indicative of the actual position.
